(19) United States
(12) Patent Application Publication
(10) Pub. No.: US 2020/0082736 A1
(43) Pub. Date: Mar. 12, 2020

(54) METHOD FOR AN AUTOMATED PREPARATION OF A PATIENT FOR A MEDICAL IMAGING EXAMINATION

(71) Applicant: Siemens Healthcare GmbH, Erlangen (DE)

(72) Inventors: Lea Schubart, Erlangen (DE); Jana Doerr, Erlangen (DE)

(73) Assignee: Siemens Healthcare GmbH, Erlangen (DE)

(21) Appl. No.: 16/562,943

(22) Filed: Sep. 6, 2019

(30) Foreign Application Priority Data
Sep. 7, 2018 (DE) 10 2018 215 278.0

(51) Int. Cl. G09B 19/00; G06F 3/01; G06F 3/16; G09B 5/00

(52) U.S. Cl. CPC G09B 19/003; G06F 3/017; G09B 5/04; G09B 5/00; G06F 3/167

(57) ABSTRACT

In a method for an automated preparation of a patient for a medical imaging examination, the preparation of the patient being carried out within a medical preparation room, patient-specific data is automatically acquired using a communications interface, the patient-specific data is evaluated, output information is generated based on the patient-specific data, and the output information is output to the patient using the communications interface.

### CROSS REFERENCE TO RELATED APPLICATIONS

This patent application claims priority to German Patent Application No. 102018215278.0, filed Sep. 7, 2018, which is incorporated herein by reference in its entirety.

### BACKGROUND

### Field

The present disclosure relates to a method for automatic preparation of a patient for a medical imaging examination, where the preparation of the patient is carried out within a medical preparation room. Moreover the present disclosure relates to a corresponding medical preparation room, which is designed for an automated preparation of a patient for a medical imaging examination. Furthermore the present disclosure relates to a computer program product with a program that is designed to carry out the method for an automated preparation of a patient for a medical imaging examination, where the preparation of the patient is carried out with a medical preparation room, as well as to an electronically-readable data medium on which the computer program product is stored.

### Related Art

For medical imaging examinations of patients the patient must be prepared beforehand for the medical imaging examination. In such cases the patient must be uniquely identified, must have the risks of the medical imaging examination explained to them and must also be prepared for the medical imaging examination, such as for example being instructed in breathing processes that the patient is to carry out during the medical imaging examination. This preparation was previously partly carried out as a manual routine by medical personnel, for example a medical technology radiology assistant (MTRA). This can often lead to problems of understanding, if for example the patient and the MTRA do not speak the same language. Moreover careless mistakes can occur with routine processes, which give the patient a feeling that the medical operating personnel are not paying sufficient attention.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a flowchart of a method for an automated preparation of a patient for a medical imaging examination according to an exemplary embodiment of the present disclosure.

FIG. 2 is a schematic illustration of a medical preparation room according to an exemplary embodiment of the present disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

The underlying object of the present disclosure is particularly to provide an individual preparation of the patient for a medical imaging examination. The object is achieved by the features of the independent claims. Advantageous embodiments are described in the dependent claims.

The disclosure is based on a method for an automated preparation of a patient for a medical imaging examination, where the preparation of the patient is carried out within a medical preparation room, with the following steps:
a) Automated acquisition of patient-specific data by means of a communications interface,
b) Evaluation of the patient-specific data, where an item of output information is generated on the basis of the patient-specific data, and
c) Output of the output information to the patient by means of the communications interface.

The medical imaging examination can include any given medical imaging examination for which a preparation of the patient is required. For example the medical imaging examination can include a magnetic resonance examination, a computed tomography examination, a PET (Positron Emission Tomography) examination, an x-ray examination etc.

In an exemplary embodiment, the automated preparation of the patient takes place using a processor and via the communications interface. The inventive method for automated preparation of the patient for a medical imaging examination is controlled by means of the processor. Communication between the patient and the processor during the preparation of the patient for the medical imaging examination preferably takes place by means of the communications interface.

In an exemplary embodiment, the processor includes software and/or computer programs stored thereon, which are stored in a memory that can be included in the processor. In an exemplary embodiment, the software and/or computer programs are additionally or alternatively stored in a separate and/or external memory. The processor can access the external memory via a data network. When the software and/or computer program is executed in the processor, the inventive method for an automated preparation of a patient for a medical imaging examination is carried out. The automated preparation of the patient is preferably carried out automatically and/or autonomously by means of the processor. In particular the inventive method is carried out without influence by and/or assistance from a user and/or medical operating personnel, for example an MTRA.

The medical preparation room preferably includes a room that is embodied specifically for preparation, in particular for automated preparation, of the patient. To this end the medical preparation room has the communications interface, which communicates with the patient during the automatic preparation. The communications interface preferably includes an acquisition system for acquisition of the patient-specific data and/or information, such as communication data for example, of the patient. In such cases the acquisition system for acquisition of the patient-specific data can include an input or also additional sensors, such as for example a camera or a weight sensor or an acoustic sensor or a movement sensor and/or a fingerprint scanner etc. Furthermore the acquisition system can also include a magnetic sensor, which detects the presence of ferromagnetic objects that the patient can be carrying on them. A magnetic sensor can be especially useful in the preparation of a patient for a magnetic resonance examination, since no ferromagnetic objects are allowed to get into the examination room here.

Moreover the communications interface can also include an output for output of communication data to the patient. The output can include a screen and/or a monitor and/or a display and/or a loudspeaker etc. The input and the output of the communications interface can also be embodied as one unit in this case, such as for example by the communications interface including a touch display. Moreover individual wall surfaces of the medical preparation room can be included in the communications interface. Here a wall surface can include a display or also just be backlit. For example a colored embodiment of a wall surface can be adapted and/or set depending on the patient. Moreover it is also conceivable for a wall surface of the medical preparation room to be used for communication with the patient and be able to be used as an input and/or output.

The patient-specific data can include data and/or information that is entered by a patient or that can be acquired by the presence of the patient within the medical preparation room. For example the patient-specific data can include a registration of the patient and/or a weight of the patient and/or a size of the patient and/or an expression of the patient and/or a speech input of the patient and/or a gesture of the patient and/or further patient-specific data and/or information appearing sensible to the person skilled in the art.

The patient-specific data is preferably evaluated by means of the processor. Here the patient-specific data is first of all transmitted by the communications interface to the processor and is subsequently evaluated there. Output information is generated by the processor on the basis of the patient-specific data. The output information preferably includes information to the patient. In such cases the output information can include speech output information and/or visual output information and/or textual output information. An instruction and/or a question and/or information can be transferred to the patient by means of the output information for example.

Moreover this output information can be integrated into a present context of the preparation. For example the patient is just greeted at the beginning of the process. Thereafter for example general details of the patient can be acquired in order subsequently to give precise instructions to the patient for the impending medical imaging examination. To this end current status information can optionally also be established by the processor on the basis of the patient-specific data in the step of evaluating the patient-specific data. The status information can advantageously include information as to the current state of the preparation, so that the output information can also be established and/or generated in the context of the current status. If for example the patient-specific data includes registration information, it can be established by means of the status information whether the registration information is introduced at the beginning of the preparation, i.e. in principle introduces the automated preparation of the patient, or is acquired at the end of the preparation for a registration for the impending the medical imaging examination. Moreover the preparatory steps that have already been run and those which are still outstanding can also be established by means of the status information.

For the output of the output information the communications interface preferably includes an output. The output in this case can include an acoustic output, such as for example a loudspeaker or headphones. Acoustic output information can be output to the patient here for example by means of a computer voice, for example a simulated computer voice. As an alternative or in addition the output can also include an optical output, such as for example a monitor and/or a display and/or a touch display and/or an illumination element etc., where optical output information and/or graphical output information and/or textual output information can be output and/or transferred to the patient by means of the optical output.

Preferably the inventive method is repeated until such time as the patient has concluded the preparation for the impending medical imaging examination. This can take place for example by the patient leaving the medical preparation room or also by registering for the impending medical imaging examination. In this way an advantageous communication between the patient and the processor can take place through the inventive method, where the patient can be prepared here step-by-step for the medical imaging examination.

The disclosure furthermore has the advantage that the preparation of the patient can be adapted individually to the patient, in particular to the patient-specific data. In this case the language of the preparation, in particular a language in which to communicate with the patient, can be adapted to a nationality and/or a choice of language of the patient. Furthermore in the preparation of the patient, in particular in the evaluation of the patient-specific data and/or of the output of the output information, an age and/or gender and/or a preference of the patient can be taken into account by the processor. In this way for example, for an output of acoustic output information, an age and/or a nationality and/or further criteria and/or characteristics of the patient can be taken into account with an articulation and a speed at which words are spoken. In particular there can be a personalized and/or individualized communication with the patient by means of the acquisition system and the output during the preparation of the patient for the medical imaging examination.

This can also lead, through the individual handling during the preparation, to the patient becoming more relaxed and/or to a feeling of wellbeing of the patient being enhanced. Moreover anxiety and/or a stress situation of the patient with regard to the impending medical imaging examination can be reduced. Furthermore errors during the preparation can also be avoided by the automated preparation of the patient for the impending medical imaging examination and the state of the patient can be explicitly checked and prepared for the impending medical imaging examination.

In an advantageous development of the inventive method there can be provision for the patient-specific data to include registration information of the patient. The registration information can include a fingerprint of the patient for example. Moreover the registration information can also include a name of the patient and/or a registration code that the patient must actively enter, such as for example by means of an input or also by means of a touch display. This advantageously enables a rapid and unique identification and/or registration of the patient to be achieved.

The registration information can for example include a registration of the patient for starting the inventive method for preparation of the patient for the medical imaging examination. Here it is advantageous for the registration information to be acquired and/or retrieved at the beginning of the method. Moreover the registration information can also include a registration of the patient for the impending medical imaging examination or only be retrieved and/or acquired for example at an end of the method for a preparation of the patient for the medical imaging examination.

Additional patient information and/or additional patient data, such as in particular a name and/or a gender and/or a nationality of the patent etc. that is stored in a memory, can be retrieved by means of the registration information, for example the fingerprint. This additional patient information and/or additional patient data is preferably linked to the registration information of the patient. This enables an especially fast registration of the patient to be carried out and a complex manual entry of this patient information by the patient, in which undesired input errors can also occur, to be dispensed with.

In an advantageous development of the inventive method there can be provision for there to be a language and/or an arrangement of the output information dependent on the registration information. Preferably in this way there can be a personalized and/or individual address and/or greeting of the patient for preparation in the medical preparation room without presettings by the patient. In this way for example patients of different age groups, such as for example children or also senior citizens, and/or patients with specific medical imaging examinations can be catered for.

In an advantageous development of the inventive method there can be provision for the patient-specific data to include a weight and/or a size of the patient. Preferably the information is acquired automatically by means of an acquisition system while the patient is located within the medical preparation room. This makes possible a simple and in particular correct provision of the weight and/or the size of the patient for the impending medical imaging examination. The Information relating to the weight and/or the size of the patient can moreover be passed on automatically by the processor to a medical imaging facility.

The weight and/or the size of the patient can be established by the processor for example from patient-specific data, which has been acquired by means of a camera. In particular a patient's weight can be deduced on the basis of their girth and/or their size by the processor. Moreover the acquisition system can also include a weight sensor (e.g. scale), which is integrated within the medical preparation room.

In an exemplary embodiment of the inventive method there can be provision for the patient-specific data to include at least one gesture of the patient and/or at least one item of voice information of the patient and/or at least one haptic input of the patient. This makes possible a simple communication of the patient with the processor, since the patient can choose that means of communication by which they can transfer information especially easily. Moreover in this way a carrying out of instructions, where the patient is transferred the instructions by means of an output, can be monitored and/or checked especially easily. In particular in this way a patient can be notified of possible errors, for example in the carrying out of breathing exercises. The voice information preferably includes acoustically perceivable information that emanates from the patient. The haptic input preferably includes an active and/or intentional input by the patient touching an input element. The haptic input of the patient can especially be performed by means of a touch display and/or a keyboard etc. of the communications interface.

In an exemplary embodiment, of the inventive method there can be provision for the patient-specific data to include at least one exercise of the patient and/or at least one carrying out of a task by the patient. In particular these exercises and/or carrying out of tasks can be relevant for the impending medical imaging examination, since here the patient can test and/or or practice a behavior during the medical imaging examination in advance. For example in this way the patient can already practice and/or undertake breathing exercises that have to be carried out later during the medical imaging examination. This advantageously enables the patient to be prepared for the impending medical imaging examination, in particular for instructions that they are to carry out during the medical imaging examination. This can also contribute to a patient being more relaxed during the medical imaging examination.

In an exemplary embodiment of the inventive method there can be provision for the patient-specific data to include settings that the patient enters. These settings can include settings for display and/or arrangement within the medical preparation room for example. For example in this way a wall color and/or lighting and/or ventilation within the medical preparation room can be defined by the patient. Especially advantageously however the settings can also include settings for the impending medical imaging examination. In this way for example the patient can set a color of lighting and/or can choose a piece of music to be played during the medical imaging examination. This embodiment of the disclosure makes available a simple choice of settings by the patient, so that during the medical imaging examination there can be a feel-good atmosphere and/or a feel-good environment available for the patient.

In an exemplary embodiment of the inventive method there can be provision for the output information to include information to the patient about the impending medical imaging examination. This information can for example include information as to approximately how long the impending medical imaging examination will last. Moreover the information can also describe a temporal sequence of the medical imaging examination for the patient for example.

Moreover the information can also include information about the way in which the medical imaging facility functions. For example, for an impending magnetic resonance examination, attention can also be drawn to the loud noises, in particular knocking noises, associated with said examination. In particular the information can also include audible examples of the medical imaging examination, in particular the magnetic resonance examination. In this way an advantageous preparation of the patient and/or an advantageous transfer of information to the patient before the medical imaging examination can be achieved.

In an exemplary embodiment of the inventive method there can be provision for the output information to include additional information to the patient that is only output if it is actively retrieved by the patient. Through this additional information the patient can advantageously be individually catered for, since only those patients that also have an interest in this additional information also receive said information. The active retrieval can include pressing a button or making a voice input for example, so that the additional information appears for the patient. The presence of the additional information can be shown to the patient by a display of an exclamation point and/or by further symbols appearing sensible to the person skilled in the art for example.

The active retrieval of the additional information in this case is included in the step of acquiring patient-specific data. The additional information in this case can include information, such as for example a way in which a medical imaging facility functions, which is of interest for a few patients, but is not necessary for carrying out the preparation of the patient and/or for carrying out the medical imaging examination.

In an exemplary embodiment of the inventive method there can be provision for the output information to include instructions for the impending medical imaging examination. The instructions can include instructions for removing ferromagnetic objects for example, as this is especially important for a subsequent magnetic resonance examination of the patient. Moreover the instructions can include instructions for removing clothing that could be an impediment for the medical imaging examination of the patient for example. The instructions can also include instructions and/or exercises for how the patient behaves during the medical imaging examination. The instructions can also include asking the patient questions in which it can be checked whether the patient has correctly understood the content transferred previously. This has the advantage that, during the preparation of the patient for the medical imaging examination, the patient can be catered for individually and for example individual steps can be repeated until such time as the patient is correctly carrying out these exercises and/or instructions.

Moreover the instructions can also include instructions for what to do in the medical preparation room. The instructions can also include instructions for interacting with the medical preparation room for example. This advantageously allows the patient to be guided through the preparation.

The disclosure is also based on a medical preparation room that is designed for automated preparation of a patient for a medical imaging examination, where the medical preparation room has a communications interface to an acquisition system and an output for communication with the patient.

The disclosure has the advantage that the preparation of the patient can be tailored individually to the patient, in particular to the patient-specific data. In this case the language of the preparation, in particular tailored to a language used for communication with the patient, to a nationality and/or to a choice of language of the patient. Furthermore in the preparation of the patient, in particular in the evaluation of the patient-specific data and/or of the output of the output information, an age and/or gender and/or a preference of the patient can be taken into account by the processor. For example in this way in an output of acoustic output information with an articulation and/or a speed at which words are spoken, an age and/or a nationality and/or further criteria and/or characteristics of the patient can be taken into account. In particular there can be a personalized and/or individualized communication with the patient during the preparation of the patient for the medical imaging examination by means of the acquisition system and the output.

This can also lead, through the individual handling during the preparation, to the patient becoming more relaxed and/or to a feeling of wellbeing of the patient being enhanced. Moreover anxiety and/or a stress situation of the patient relating to the impending medical imaging examination can also be reduced. Furthermore, through the automated preparation of the patient for the impending medical imaging examination, errors during the preparation can be avoided and the state of the patient explicitly checked and prepared for the impending medical imaging examination.

The advantages of the inventive medical preparation room essentially correspond to the advantages of the inventive method for an automated preparation of a patient for a medical imaging examination, which are set down in detail above. Features, advantages or alternate forms of embodiment mentioned here can likewise also be transferred to the other claimed subject matter and vice versa.

In an exemplary embodiment of the inventive medical preparation room, the communications interface includes at least one wall surface of the medical preparation room, where a color of the wall surface and/or a display on the wall surface is adjustable. Preferably the wall surface of the medical preparation room is included here in the output of the communications interface. As an alternative or in addition there can also be provision for the wall surface of the medical preparation room to be included in the acquisition system. The wall surface of the medical preparation room can include a touch display and/or a monitor and/or a backlit surface etc. for example. Preferably the wall surface is integrated into a wall of the medical preparation room. The wall surface is also preferably arranged within the medical preparation room. In this way for example, by setting a color of the wall surface, a calming mood can be created within the medical preparation room or also through the colored arrangement of the wall surface it is possible to cater to a mood of the patient during the preparation of the patient for the medical imaging examination. For example with small children, pictures of animals or age-appropriate themes can be displayed. Moreover, by displaying it on the wall surface, a good visibility of output information can be provided for the patient.

In an exemplary embodiment, the acquisition system includes an acoustic acquisition system and/or an optical acquisition system. The acoustic acquisition system can include a microphone and/or an acoustic sensor for example. The optical acquisition system can include a camera and/or an optical sensor for example, such as for example a movement sensor. Moreover there can also be provision for the acquisition system of the communications interface to include a tactile and/or haptic acquisition system, such as for example a touch display and/or a keyboard etc. This makes it possible for the patient to easily enter patient-specific data and/or information. In particular here, as a result of different acquisition systems, the patient can make the patient-specific data and/or information available in different ways.

In an exemplary embodiment of the medical preparation room, the output includes an acoustic and/or an optical output. The acoustic output can include a loudspeaker and/or headphones and/or further acoustic output means for example, by means of which acoustic output information can be output for example by means of a computer voice. The optical output can include a monitor and/or a display and/or a touch display and/or further optical output means for example. Moreover the optical output can also include a light element, by means of which a lighting mood can be generated within the medical preparation room. This enables a simple and rapid transfer of information to the patient to be achieved for an output of output information.

In an exemplary embodiment of the inventive medical preparation room, the medical preparation room includes a processor configured to control the communications interface. This advantageously enables an autonomous control of the medical preparation room to be provided.

In an exemplary embodiment, the processor is configured to control the operation of one or more components of the medical preparation room, such as the touch display, acquisition system, communication interface, input, output, etc.

The disclosure is further based on a computer program product, which includes a program and is able to be loaded directly into a memory of a programmable processor, with program means for carrying out a method for an automated preparation of a patient for a medical imaging examination when the program is executed in the processor. In this case the computer program might possibly need program means, e.g. libraries and auxiliary functions, in order to realize the corresponding forms of embodiment of the method. The computer program in such cases can be software with a source code that still has to be compiled and linked or which only has to be interpreted, or can include executable software code, which only has to be loaded into a corresponding processor to be executed.

The inventive computer program product is able to be loaded directly into a memory of a programmable processor and has program code means for carrying out an inventive method for an automated preparation of a patient for a medical imaging examination when computer program product is executed in the processor. The computer program product can be a computer program or include a computer program. This enables the inventive method to be carried out quickly, identically repeatably and robustly. The computer program product is configured in such a way as to be able to carry out the inventive method steps by means of the processor. In this case the processor must have the prerequisites in each case, such as for example a corresponding main memory, a corresponding graphics card or a corresponding logic unit, so that the respective method steps are able to be carried out efficiently. The computer program product is stored on a computer-readable medium for example or held on a network or server, from where it can be loaded into the processor, which is directly connected to the magnetic resonance facility or can be embodied as a part of it. Furthermore control information of the computer program product can be stored on an electronically-readable data medium. The control information of the electronically-readable data medium can be embodied in such a way that, when the data medium is used in a processor, it carries out an inventive method. The computer program product can thus also represent the electronically-readable data medium. Examples of electronically-readable data media are a DVD, a magnetic tape, a hard disk or a USB stick, on which electronically-readable control information, in particular software (cf. above), is stored. When this control information (software) is read from the data medium and stored in a controller and/or processor, all inventive forms of embodiment of the method described above are carried out. Thus the disclosure can also be based on the said computer-readable medium and/or the said electronically-readable data medium.

Furthermore the disclosure is based on a computer-readable data medium, which includes a program that is intended for carrying out a method for an automated preparation of a patient for a medical imaging examination.

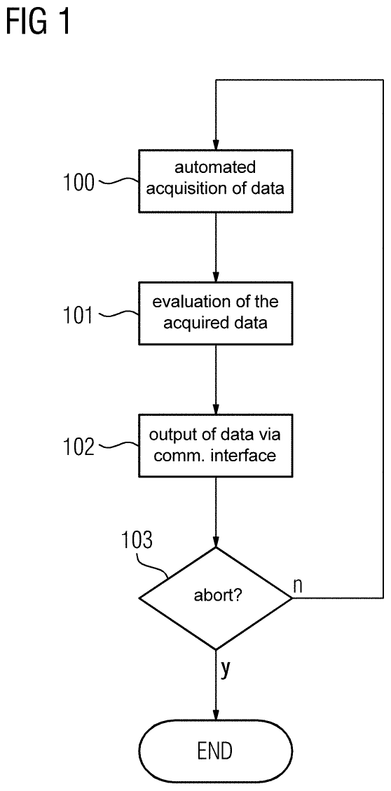

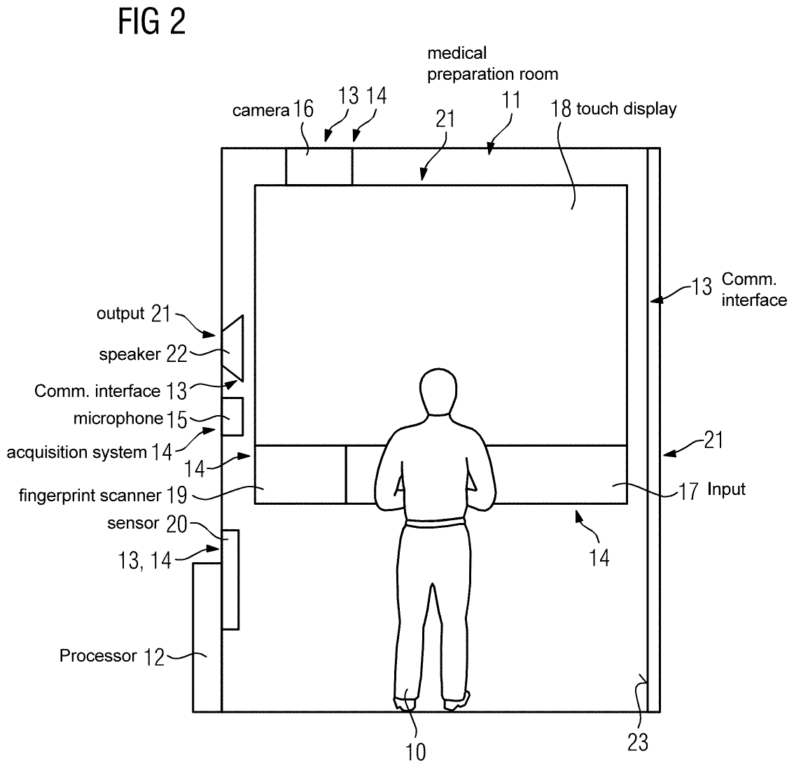

Shown in FIG. 1 is an inventive method for an automated preparation of a patient 10 for a medical imaging examination. The medical imaging examination in this case can include any medical imaging examination appearing sensible to the person skilled in the art. For example the medical imaging examination can include a magnetic resonance examination or a computer tomography examination or a PET (Positron Emission Tomography) examination or an x-ray examination etc. The automated preparation of the patient 10 for the medical imaging examination is carried in this case in a medical preparation room 11. Such a medical preparation room is shown in greater detail in FIG. 2.

In an exemplary embodiment, the medical preparation room 11 includes a processor 12 and a communications interface 13. To this end the processor 12 includes software and/or computer programs, which can be stored in a memory not shown in any greater detail, which can be included in the processor 12. The software and/or computer programs can however also be stored in a separate and/or external memory, which the processor 12 is able to access by means of a data network. Moreover the computer programs and/or software can also be stored on an electronically-readable data medium, which has a data connection to the processor 12 for an exchange of data. In an execution of the software and/or computer program, the processor 12 performs one or more operations of the method for an automated preparation of a patient for a medical imaging examination. The automated preparation of the patient 10 is preferably carried out automatically and/or autonomously by means of the processor 12. In particular the inventive method is carried out without the influence and/or without the assistance of a user and/or medical operating personnel, for example an MTRA.

The communications interface 13 is arranged within the medical preparation room 11, so that there can be a communication with a patient 10 located within the medical preparation room 11 during the preparation of the patient 10 for the impending medical imaging examination by means of the communications interface 13. Moreover the communications interface 13 is connected to the processor 12 via a data exchange unit not shown in any greater detail. The communications interface 13 has an acquisition system 14, by means of which patient-specific data and/or information can be acquired. The acquisition system 14 in the present exemplary embodiment includes an optical acquisition system and an acoustic acquisition system. The acquisition system can also include just an optical acquisition system or also just an acoustic acquisition system. Moreover the acquisition system can also include a haptic and/or tactile acquisition system.

The acoustic acquisition system in the present exemplary embodiment includes a microphone 15. Moreover the acoustic acquisition system can include further acoustic sensors. The optical acquisition system in the present exemplary embodiment includes a camera 16. Moreover the optical acquisition system can include further optical sensors, such as for example a movement sensor etc. The acquisition system 14 furthermore has an input 17. The input 17 includes a keyboard and a touch display 18 for example, which are arranged within the medical preparation room 11.

Furthermore the acquisition system 14 in the present exemplary embodiment includes a fingerprint scanner 19, by means of which there can be a unique identification and/or registration of the patient 10. The acquisition system 14 in the present exemplary embodiment moreover includes a sensor 20 for detection of ferromagnetic objects, such as is of particular advantage for a preparation of a patient 10 for a magnetic resonance examination. The acquisition system 14 can moreover include further sensors and/or acquisition means for acquisition of patient-specific data and/or information, such as for example a weight sensor etc., appearing sensible to the person skilled in the art.

The communications interface 13 furthermore includes an output 21. The output 21 in the present exemplary embodiment includes an acoustic output, such as for example a loudspeaker 22 and/or headphones. Moreover the acoustic output can include further acoustic output means. Furthermore the output 21 includes an optical output. The optical output includes a display and/or a monitor for example. The acquisition system 14 and the output 21 are moreover partly embodied in one piece with one another and include the touch display 18. Moreover the optical output 21 in the present exemplary embodiment includes a wall surface 23 of the medical preparation room 11. The wall surface 23 can be embodied as the display for display and/or output of information to the patient 10. Moreover the wall surface 23 can also just be backlit, so that in this way a different coloring of the medical preparation room 10 can be provided.

The inventive method for automated preparation of the patient 10 for the impending medical imaging examination is controlled by the processor 12. Here, in a first method step 100, there is an automated acquisition of patient-specific data and/or information by means of the communications interface 13, in particular the acquisition system 14 of the communications interface 13.

The patient-specific data and/or information here includes data and/or information which can be acquired by the patient 10 by means of the communications interface 13 or also be actively communicated and/or input by the patient 10 by means of the communications interface 13 during the preparation for the medical imaging examination. Moreover the patient-specific data can include data and/or information already stored, which is stored in a database for the impending medical imaging examination, such as for example the name of the patient 10 and/or an age of the patient 10 and/or a gender of the patient 10 and/or type of examination for the impending medical imaging examination.

The acquired patient-specific data here can include registration information of the patient 10. Such registration information can be acquired by means of the fingerprint scanner 19. As an alternative the registration information can also be provided by means of the touch display 18 or the input 17, by the patient 10 actively entering registration information. Moreover the patient-specific data and/or information can include a weight and/or a size of the patient 10, which can be acquired for example by means of a weight sensor and/or a camera of the acquisition system 14.

Furthermore the acquired patient-specific data can include at least one gesture of the patient 10 and/or at least one item of speech information of the patient 10 and/or a haptic input of the patient 10. A gesture of the patient 10 can be acquired for example by means of the camera 16 or a movement sensor of the acquisition system 14. The speech information of the patient 18 can preferably be acquired by means of a microphone 15 of the communications interface 13, in particular of the acquisition system 14. The haptic input can in particular be made by means of the touch display 18 or the input 17 of the communications interface 13, in particular of the acquisition system 14.

The patient-specific data and/or information can also moreover include an exercise of the patient 10 and/or at least one execution of a task by the patient 10. This exercise and/or the execution of the task can for example include a breathing exercise, where breathing states defined here, such as for example breathing in and longer periods of holding the breath or breathing out and longer periods of holding the breath etc., for the impending medical imaging examination can be practiced by the patient 10. Moreover the exercise and/or the carrying out of the task can also include an interaction of the patient 10 with a patient interface of the medical imaging facility during the impending medical imaging examination. For example an interaction, in particular a correct interaction, of the patient 10 with a patient call ball or a patient monitor etc. can be practiced. To do this, a patient interface of the medical imaging facility of this type can also be simulated by the processor 12 and output on the output, in particular a monitor or the touch display 18.

Moreover the patient-specific data and/or information can include settings that the patient 10 can enter by means of the acquisition system 14. These settings can include settings for display and/or arrangement within the medical preparation room 11 for example. For example in this way a wall color and/or lighting and/or ventilation within the medical preparation room 11 can be defined by the patient 10. Furthermore the settings can also include settings for the impending medical imaging examination. In this way for example the patient 10 can set a color of lighting of an examination room and/or make a choice of a piece of music that is to be played during the medical imaging examination.

In a second method step 101 following on from the first method step 100 there is an evaluation of the patient-specific data and/or information, where output information is generated on the basis of the patient-specific data and/or information. The patient-specific data and/or information is evaluated here by means of the processor 12. In particular the patient-specific data and/or information is evaluated in an automated manner by means of the processor 12. Moreover the output information is also generated in an automated manner by means of the processor 12 on the basis of the acquired patient-specific data and/or information.

In this second method step 101 the acquired patient-specific data and/or information is evaluated by the processor 12 in the context of the impending medical imaging examination on the patient 10. The output information generated by the processor 12 serves to guide a communication with the patient 12 for preparation of the patient 12, where the preparation of the patient 12 for the impending medical imaging examination includes both a registration of the patient 12 and also informing the patient 12 about the impending medical imaging examination.

Moreover, in this second method step, current status information can also be established optionally by the processor 12 on the basis of the patient-specific data. The status information can advantageously include information as to the current status of the preparation, so that the output information can also be established and/or generated in the context of the current status. If for example the patient-specific data includes registration information, it can be established by means of the status information whether the registration information is acquired at the beginning of the preparation, i.e. in principle introduces the automated preparation of the patient 10, or at the end of the preparation for a registration for the impending medical imaging examination. Moreover the preparation steps that have already been carried out and those still outstanding can also be determined by means of the status information.

In a third method step 102 following on from the second method step 101 there is an output of the output information to the patient 10 by means of the communications interface 13. In particular the output of the output information by means of the output 21 of the communications interface 13. The output information can include acoustic output information, which can be output by a simulated computer voice by means of the acoustic output. Moreover the output information can also include optical output information.

The output information can include an instruction, in particular an instruction to the patient 10 as to what action to take and/or an instruction about carrying out an exercise and/or a task for example. The instruction can include acoustic output information, which can be output to the patient 10 by means of the acoustic output, or also optical output information, which can be output to the patient 10 by means of the optical output.

Furthermore the output information can also include information to the patient 10 for the impending medical imaging examination. The information can in particular include acoustic output information, which can be output to the patient 10 by means of the acoustic output, or also optical output information, which can be output to the patient 10 by means of the optical output.

Moreover the output information can also include additional information, which is only output when actively retrieved by the patient 10. For example this type of additional information can include a way in which the medical imaging facility functions, which can be displayed and/or output only at the request of the patient 10. The patient 10 is preferably made aware of this type of additional information by a symbol, in particular an acoustic symbol or also an optical symbol, such as for example an exclamation point and/or display of a warning triangle. This additional information can include acoustic output information here, which can be output to the patient 10 by means of the acoustic output, or also optical output information, which can be output to the patient 10 by means of the optical output.

The inventive method for automated preparation of the patient 10 for the impending medical imaging examination begins as soon as the patient 10 has entered the medical preparation room 11 or has registered for the preparation. The method steps 100 to 102 can be repeated here for as long as the preparation of the patient 10 for the medical imaging examination lasts. A communication with the patient 10 for preparation of the patient 10 is carried out here by means of the method steps 100 to 102. The method for preparation of the patient 10 only ends once an abort criterion 103 is present. Such an abort criterion 103 is present when the patient 10 leaves the medical preparation room 11 or the patient 10 registers himself for the impending medical imaging examination.

For example registration information of the patient 10 can be acquired in a first method step 100. The method for preparation of the patient 10 for the medical imaging examination begins by means of this registration information. This registration information can be available for example by means of an acquisition of a fingerprint of the patient 10. Moreover there can also be provision for the registration information to be provided by entry of the name of a patient 10 and/or an access code of the patient 10. This registration information can moreover be linked to further patient data and/or patient information, where this further patient data and/or patient information can be stored and/or held in a memory, which is connected to the processor 12. This further patient data and/or patient information can include a name of the patient 10 and/or an age of the patient 10 and/or a gender of the patient 10 and/or a nationality of the patient 10 and/or a preferred language for communication with the patient 10 for example. This patient data and/or patient information can be read out by the processor 12 and evaluated in the second method step 101.

Then, in the third method step 102, a greeting can be given to the patient 10 by means of the output 21, where a language of communication and a speed of communication and/or means of communication can be established by the processor 12 depending on the patient data and/or patient information in the second method step 101. For example a speed and/or an articulation of the communication for an age of the patient 10 can be determined by the processor 12 in the second method step 101. For example the speed at which a computer voice speaks and/or the speed of the preparation of the patient 12 can be slower for children or older patients than for patients 12 of normal adult age, in order in this case to avoid making too many demands on the patient 12. Furthermore for example a language can be determined for a nationality of the patient 10 by the processor 12 in the second method step 101. Also for example lighting and/or arrangement of the medical preparation room 11 can be determined by the processor 12 for the patient data and/or patient information, in particular for an age and/or for a gender of the patient 10 etc. in the second method step 101.

Moreover, in the third method step 102, information can also be output to the patient 10, which informs the patient 10 about interacting with the medical preparation room. As an alternative or in addition requests and/or instructions to the patient 10 can be output in the third method step 101 to practice interacting with the medical preparation room 11. Carrying out the exercises and/or instructions correctly can be detected in the first method step 100 and monitored and/or checked in the second method step 101. For example, even with output of only one item of information in the third method step 102, it can be required that a confirmation by the patient 10 in the first method step 101 is detected or entered in order to continue with the preparation of the patient 10. Such confirmation inputs by the patient 10 can for example also be interpreted in a second method step 101 as an item of status information.

Moreover, in the third method step 102, information can also be output to the patient 10 that informs the patient 10 about the impending medical imaging examination. There can also be provision here, on the basis of an algorithm, for the information output to the patient 10 to be able to be adapted by the processor 12 using intermediate questions to the patient 10. In particular the information output to the patient 10 is adapted automatically here in a second method step 101 by the processor 12, in particular by the algorithm of the processor 12, to answers of the patient 10 acquired in a first method step 100.

The information that can be output in a third method step 102 to the patient 10 can include a duration of the examination and/or a temporal sequence of the medical imaging examination etc. Moreover individual information can also be output as additional information, just by the patient 10 clicking on or pressing a button for example, where this can be detected in a first method step 100 and evaluated by the processor 12 in a second method step 101, the additional information can be output to the patient 10 in a third method step 102.

To check whether the information and/or instructions have been correctly understood by the patient 10, there can also be provision, in a second method step 101, for the output information to be generated that includes questions to the patient 10 about their understanding. This can be sensible in particular in very important situations or also in situations where the patient is at risk, such as in particular the removal of ferromagnetic objects before a magnetic resonance examination.

Moreover there can also be provision, in a third method step 102, for instructions to be output for practicing breathing processes that are important for the impending medical imaging examination. This can take place for example on the basis of an output of acoustic sounds and/or of pictures to the patient 10. A detection as to whether the patient is correctly carrying out these instructions and/or exercises, can be undertaken in the first method step 100 and established by the processor 12 in a second method step 101.

Moreover it can be that, in a first method step 100 during the preparation of the patient 10, a weight and/or a size of the patient 10 is acquired. Such information can be passed on automatically by the processor 12 to the medical imaging facility.

There can also be provision, in a first method step 100, during the preparation of the patient 10, for the patient 10 to be able to make settings for the impending medical imaging examination. The patient 10 can also be requested to do so here by a previous third method step 102, in which output information is output to the patient 10 with an instruction to enter settings for the impending medical imaging examination. Such settings can include a color of lighting and/or a choice of a piece of music that is to be played during the medical imaging examination, and/or a setting relating to a supply of air for a patient receiving area of the medical imaging facility for example.

There can also be provision, in a third method step 102 during the preparation of the patient 10, for the patient 10 to be requested to remove ferromagnetic objects. This can also be monitored and/or controlled in a subsequent first method step 100, for example by the camera 16 and/or by the ferromagnetic sensor 20. Moreover the patient 10 can be requested in a third method step 102 during the preparation of the patient 10 to remove specific items of clothing that could be an impediment in the medical imaging examination.

There can also be provision, in a first method step 100 during the preparation of the patient 10, for the patient 10 to be able to be identified and/or registered for the medical imaging examination. This can once again take place by means of acquiring a fingerprint of the patient 10.

As an alternative or in addition, further patient-specific data and/or information appearing sensible to the person skilled in the art can be acquired in a first method step 100. Moreover it is conceivable for further output information to be generated in a second method step 101 and to be output in the third method step 102.

Although the disclosure has been illustrated and described in greater detail by the preferred exemplary embodiment, the disclosure is not restricted by the disclosed examples and other variations can be derived herefrom by the person skilled in the art, without departing from the scope of protection of the disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processor circuitry” shall be understood to be circuit(s), processor(s), logic, or a combination thereof. A circuit includes an analog circuit, a digital circuit, state machine logic, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM).

The memory can be non-removable, removable, or a combination of both.

1. A method for an automated preparation of a patient for a medical imaging examination, the preparation of the patient being carried out within a medical preparation room having a processor and a communication interface, the method comprising:
automatically acquiring, using the processor, patient-specific data via the communications interface;
evaluating, using the processor, the patient-specific data;
generating, by the processor, output information based on the evaluation of the patient-specific data; and
outputting, by the processor, the output information to the patient via the communications interface.

2. The method as claimed in claim 1, wherein the patient-specific data comprises an item of registration information of the patient.

3. The method as claimed in claim 2, wherein the registration information is linked to further patient information and/or patient data.

4. The method as claimed in claim 2, wherein the output information is in a language that depends on the registration information.

5. The method as claimed in claim 2, wherein the output information has an arrangement that is based on the registration information.

6. The method as claimed in claim 1, wherein the patient-specific data comprises a weight and/or size of the patient.

7. The method as claimed in claim 1, wherein the patient-specific data comprises one or more of: at least one gesture of the patient; at least one item of speech information of the patient; and at least one haptic input of the patient.

8. The method as claimed in claim 1, wherein the patient-specific data comprises one or more of: at least one exercise to be performed by the patient, and at least one task to be performed by the patient.

9. The method as claimed in claim 1, wherein the patient-specific data comprises settings entered by the patient.

10. The method as claimed in claim 1, wherein the output information comprises information about the impending medical imaging examination.

11. The method as claimed in claim 1, wherein the output information comprises additional information associated with the patient, the additional information only being output to the patient when actively retrieved by the patient.

12. The method as claimed in claim 1, wherein the output information comprises instructions for the impending medical imaging examination.

13. A computer program product having a computer program which is directly loadable into a memory of a programmable processor, when executed by the programmable processor, causes the medical preparation room to perform the method as claimed in claim 1.

14. A non-transitory computer-readable storage medium with an executable program stored thereon, that when executed, instructs the processor of the medical preparation room to perform the method of claim 1.

15. A medical preparation room for an automated preparation of a patient for a medical imaging examination, comprising:
a communications interface with an acquisition system configured to automatically acquire patient-specific data; and
a processor configured to:
evaluate the patient-specific data;
generate output information based on the evaluation of the patient-specific data; and
output the output information to the patient via an output of the communications interface.

16. The medical preparation room as claimed in claim 15, wherein the communications interface comprises at least one wall surface of the medical preparation room, a color of the at least one wall surface and/or a display on the at least one surface being configurable.

17. The medical preparation room as claimed in claim 15, wherein the acquisition system comprises an acoustic acquisition system and/or an optical acquisition system.

18. The medical preparation room as claimed in claim 15, wherein the output comprises a speaker and/or display.

19. The medical preparation room as claimed in claim 15, wherein the processor is further configured to control the communications interface.
